(19) United States
(12) Patent Application Publication
(10) Pub. No.: US 2019/0107750 A1
(43) Pub. Date: Apr. 11, 2019

(54) CURVED DISPLAY PANEL AND CURVED DISPLAY APPARATUS

(71) Applicants: HKC CORPORATION LIMITED, GUANGDON (CN); CHONGQING HKC OPTOELECTRONICS TECHNOLOGY CORPORATION LIMITED, CHONGQING (CN)

(72) Inventor: Yu-jen Chen, Taiwan (CN)

(73) Assignees: HKC CORPORATION LIMITED, GUANGDON (CN); CHONGQING HKC OPTOELECTRONICS TECHNOLOGY CORPORATI ON LIMITED, CHONGQING (CN)

(21) Appl. No.: 15/556,327

(22) PCT Filed: Apr. 12, 2017
(86) PCT No.: PCT/CN2017/080293

§ 371 Date: Sep. 7, 2017

(30) Foreign Application Priority Data
Dec. 23, 2016 (CN) 201611207158.1

(51) Int. Cl. G02F 1/1333; G02F 1/1335

(52) U.S. Cl. CPC G02F 1/133308; G02F 1/133305; G02F 2201/56; G02F 2202/28; G02F 1/133514

(57) ABSTRACT

A curved display panel and a curved display apparatus are provided. The curved display panel includes: a first substrate; a second substrate opposite to the first substrate, each of the first substrate and the second substrate includes two opposite first side frames having a predetermined curvature and two opposite second side frames; and a frame glue coated at a peripheral location between the first substrate and the second substrate. The frame glue includes a first frame glue for sealing the first side frames and a second frame glue for sealing the second side frames. When the curved display panel is in a planar state, a width of the second frame glue is positively correlative to the predetermined curvature.

### TECHNICAL FIELD

The present disclosure relates to the field of display technology, in particular to a curved display panel and a curved display apparatus.

### BACKGROUND

With the development of display technology, a curved display panel comes into being and has been widely used because of its good visual effects. Currently, a curved display panel is usually manufactured in the following process: a display panel is first made into a planar structure and then is bent to form a curved display panel.

According to a curved liquid crystal display panel in the related art, usually the frame glue in the frame glue region of a flat first substrate and the frame glue in the frame glue region of a flat second substrate are totally cured and then the first and second substrates are bent. The first substrate and the second substrate of the display panel are usually made of glass while the frame glue is elastic, so that the frame glue between the un-curved side frame of the first substrate and that of the second substrate is deformed in a width direction of the frame glue so as to alleviate stress on the two substrates. However, the frame glue has a great force to restore its original state due to its particular characteristics, making the substrates fall off, causing a larger cell thickness of the liquid crystal on at least two sides of the display panel, leading to deviated outgoing light and a decreased transmittance, thereby affecting the display chromaticity and display brightness.

### SUMMARY

In view of the above, a curved display panel and a curved display apparatus are provided, so as to solve the problem that adhesion between a first substrate and a second substrate is poor, to prevent the first substrate and the second substrate from falling off during the bending process, and to improve the display chromaticity and display brightness.

According to an aspect, an embodiment of the present disclosure provides a curved display panel, including:

a first substrate;

a second substrate oppositely arranged to the first substrate, where the first substrate includes a first side frame and a second side frame of a predetermined first curvature, the second substrate includes a third side frame and a fourth frame of the predetermined first curvature, the first side frame and the third side frame are oppositely arranged, and the second side frame and the fourth side frame are oppositely arranged; and

a frame glue, the frame glue is coated at a peripheral location between the first substrate and the second substrate and includes a first frame glue for sealing the first side frame and a second frame glue for sealing the second side frame.

When the curved display panel is in a flat state, a width of the second frame glue is positively correlative to the predetermined first curvature.

According to another aspect, an embodiment of the present disclosure provides a curved display apparatus including the curved display panel described in the above aspect.

The present disclosure has the following advantages: according to the curved display panel and the curved display apparatus of the present disclosure, before the curved display panel is bent, that is, when the display panel is in the flat state, the peripheral location between the first substrate and the second substrate is coated with the frame glue, the width of the frame glue between the side frames not to be bent, of the first and second substrates are arranged according to the predetermined first curvature of the side frames are to be bent, of the first and second substrates, and the width of the frame glue is positively correlative to the predetermined first curvature so as to increase the adhesion between the first substrate and the second substrate of the curved display panel with different curvatures. The present disclosure solves the problem that adhesion between the first substrate and the second substrate is poor, prevents the first substrate and the second substrate from falling off during the bending process, and improves the display chromaticity and display brightness.

### BRIEF DESCRIPTION OF DRAWINGS

The above and other features and advantages of the present disclosure will become apparent to those of ordinary skill in the art by describing in detail the exemplary embodiments of the present disclosure with reference to the accompanying drawings. In the accompanying drawings:

FIG. 1 is a schematic diagram showing a structure of a curved display panel according to an embodiment of the present disclosure;

FIG. 2 is a schematic diagram showing a structure of the curved display panel in a flat state according to an embodiment of the present disclosure;

FIG. 3 is a schematic diagram showing a structure of another curved display panel according to an embodiment of the present disclosure;

FIG. 4 is a schematic diagram showing a structure of a curved display apparatus according to an embodiment of the present disclosure; and

FIG. 5 is a schematic diagram showing another structure of a curved display apparatus according to an embodiment of the present disclosure.

### DETAILED DESCRIPTION

The technical solution of the present disclosure will be further described below with reference to the accompanying drawings and by way of specific embodiments. It is to be understood that the specific embodiments described herein are intended to illustrate and not to limit the present disclosure. It is to be noted that, for the sake of convenience of description, only parts of the present disclosure and not all structures are shown in the accompanying drawings.

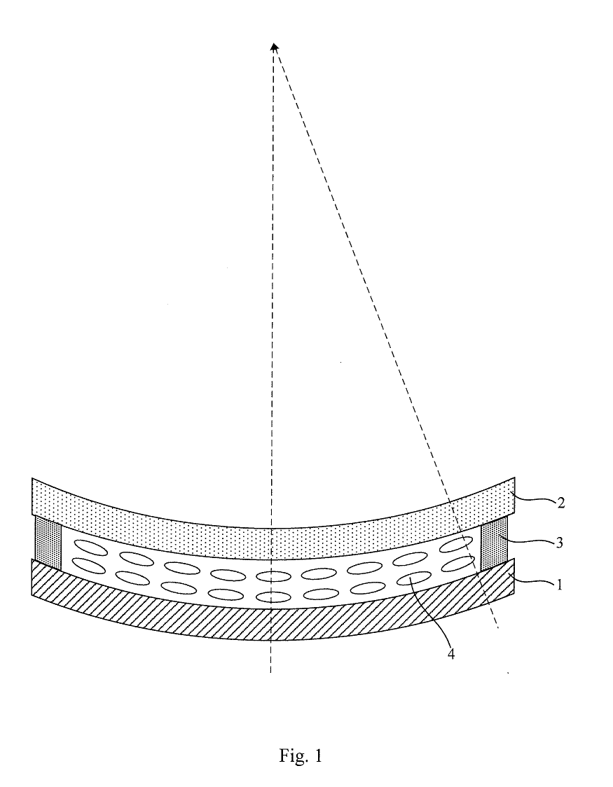

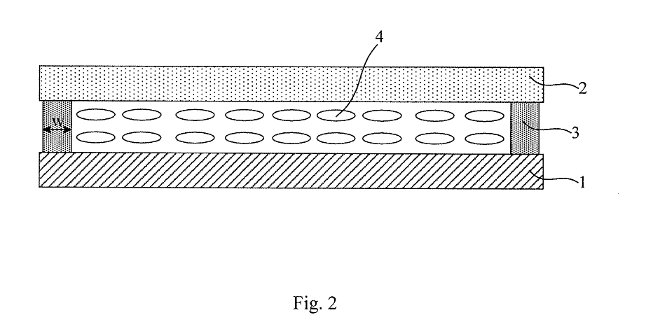

FIG. 1 is a schematic diagram showing a structure of a curved display panel according to an embodiment of the present disclosure. FIG. 2 is a schematic diagram showing a structure of the curved display panel in a flat state according to an embodiment of the present disclosure. In conjunction with FIGS. 1 and 2, the curved display panel includes: a first substrate 1, a second substrate 2 oppositely arranged to the first substrate, and a frame glue coated at a peripheral location between the first substrate 1 and the second substrate 2.

Each of the first substrate 1 and the second substrate 2 includes two opposite first side frames of a predetermined curvature (not shown in the drawings) and two opposite second side frames (not shown in the drawings).

The frame glue includes a first frame glue (not shown in the drawings) for sealing the first side frame and a second frame glue 3 (not shown in the drawings) for sealing the second side frame.

When the curved display panel is in a flat state, a width w of the second frame glue 3 is positively correlative to the predetermined curvature.

Optionally, in the present embodiment, for example, the first substrate 1 is an array substrate, the second substrate 2 is a color filter substrate, and the frame glue may be coated on at least one of the array substrate and the color filter substrate.

In some embodiments, a switch (such as TFT) array and the color filter may be formed on a same substrate.

The liquid crystal 4 is filled between the array substrate and the color filter substrate. The frame glue can seal the liquid crystal 4 between the first substrate 1 and the second substrate 2 to prevent the liquid crystal 4 from leaking.

In addition, the first substrate 1 described above is the array substrate, and the second substrate 2 described above may also be an encapsulation cover plate.

The larger the predetermined curvature is, the greater the bending angle of the curved display panel is, and the greater the stress between the frame glue and the first substrate 1 and the second substrate 2 is, and therefore, the first substrate 1 and the second substrate 2 are more likely to fall off. Therefore, in the present embodiment, in the process of manufacturing the planar structure of the curved display panel, the width w of the second frame glue 3 is arranged to increase with the increase of the predetermined curvature. That is, when the predetermined curvature is large, contact areas between the second frame glue 3 and the first substrate land the second substrate 2 are increased so as to increase adhesion between the first substrate 1 and the second substrate 2. In the present embodiment, the width of the second frame glue is greater than 1 mm. For example, when the predetermined curvature is 1/4000 mm⁻¹, the width w of the second frame glue 3 is equal to 1.1 mm; when the predetermined curvature is 1/3000 mm⁻¹, the width w of the second frame glue 3 is equal to 1.3 mm; and when the predetermined curvature is 1/2000 mm⁻¹, the width w of the second frame glue 3 is equal to 1.7 mm.

Optionally, when the curved display panel is in the flat state, the width w of the second frame glue 3 is not less than a width of the first frame glue. This is because when the planar structure of the curved display panel is bent, although the first frame glue is deformed in a length direction, the contact areas between the first frame glue and the first substrate 1 and the second substrate 2 are large enough, that is, adhesion between the first substrate 1 and the second substrate 2 at the first side frame is good. In order to save the inner space of the panel, the width of the first frame glue may be arranged to be relatively small, for example, 1 mm. With the increase of the bending curvature, the greater the deformation of the second frame glue 3 in its width direction is, the larger the restoring force of the second frame glue 3 is, so that the first substrate 1 and the second substrate 2 are more likely to fall off. Therefore, the width w of the second frame glue 3 is arranged to be relative large. However, in order not to affect the display of the curved display panel, the width w of the second frame glue 3 cannot be infinitely increased as the predetermined curvature increases. Therefore, the frame glue (the second frame glue) is disposed in a non-display region of the curved display panel.

Optionally, the Young's modulus of the second frame glue 3 is not less than that of the first frame glue. The magnitude of the Young's modulus reflects the ability of the material to resist elastic deformation under external forces. According to the foregoing analysis, it can be seen that adhesion between the first substrate 1 and the second substrate 2 at the first side frame is preferable, and therefore, the first frame glue may be made of a material having a smaller Young's modulus or may be added with material to decrease the Young's modulus. The second frame glue 3 uses a material having a larger Young's modulus so that the second frame glue 3 is less likely to be elastically deformed in the width direction when the planar structure of the curved display panel is being bent and after having been bent, thereby further preventing the first substrate 1 and the second substrate 2 from falling off.

In the present embodiment, the Young's modulus of the first frame glue cannot be too small, otherwise the liquid crystal will leak. Optionally, a range of the Young's modulus of the first frame glue may be 0.1 GPa to 1.6 GPa. The Young's modulus of the second frame glue 3 cannot be too large, otherwise there will be a dark state light leakage problem, a range of the Young's modulus of the second frame glue 3 may be 1.6 GPa to 2 GPa.

In the present embodiment, the frame glue described above may include epoxy resin, acrylate, photoinitiator and thermal hardener.

Optionally, when the planar structure of the curved display panel is being bent, referring to FIG. 1, the first substrate 1 is bent towards the second substrate 2; or

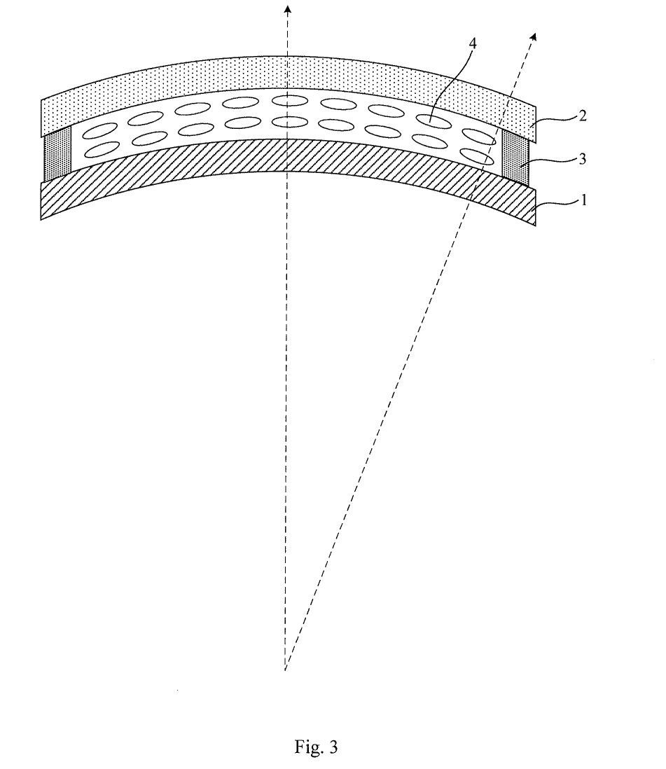

referring to FIG. 3, the second substrate 2 is bent towards the first substrate 1.

According to the curved display panel and the curved display apparatus of the present disclosure, before the curved display panel is bent, that is, when the display panel is in the flat state, the peripheral location between the first substrate and the second substrate is coated with the frame glue, the width of the frame glue between the side frames not to be bent, of the first and second substrates are arranged according to the predetermined first curvature of the side frames to be bent, of the first and second substrates, and the width of the frame glue and the predetermined first curvature are in the positive correlation relationship so as to increase the adhesion between the first substrate and the second substrate of the curved display panel with different curvatures. The present disclosure solves a problem that the adhesion between the first substrate and the second substrate is poor, prevents the first substrate and the second substrate from falling off during the bending process, and improves the display chromaticity and display brightness.

An embodiment of the present disclosure provides a curved display apparatus including the curved display panel provided by the above embodiments of the present disclosure.

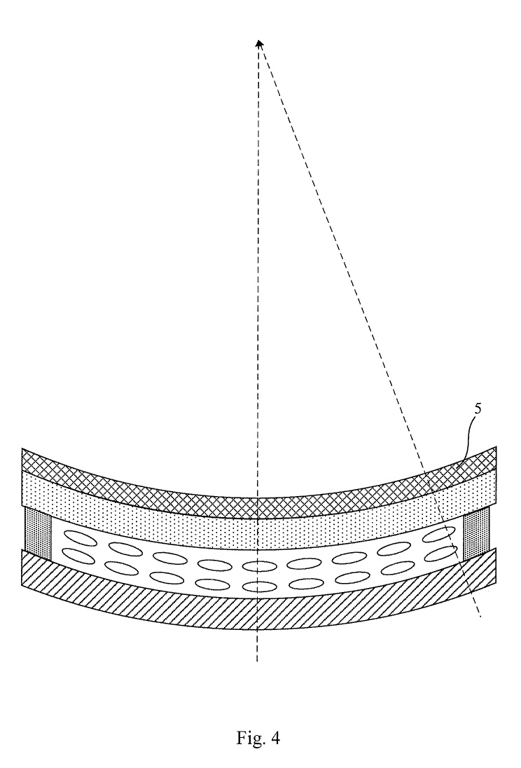

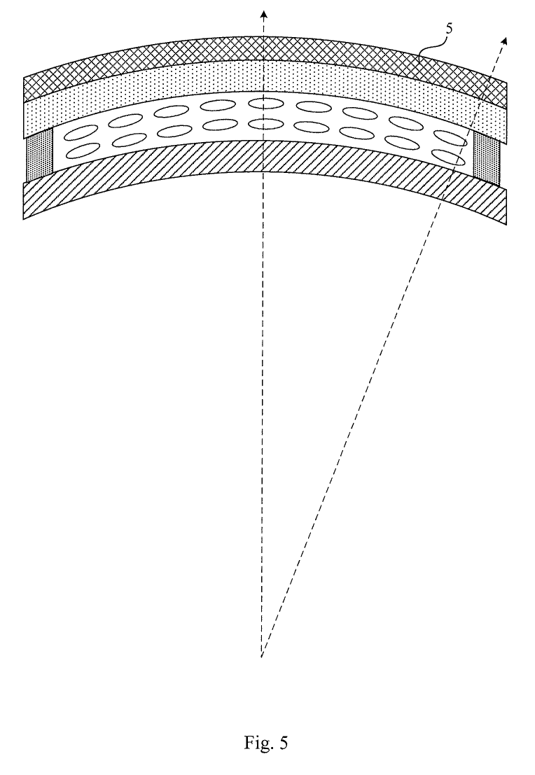

Exemplarily, FIG. 4 is a schematic diagram showing a structure of a curved display apparatus according to an embodiment of the present disclosure, and FIG. 5 is a schematic diagram showing another structure of a curved display apparatus according to an embodiment of the present disclosure.

With reference to FIG. 4, the curved display apparatus includes the curved display panel shown in FIG. 1 and a cover plate 5. The first substrate is bent towards the second substrate, and the cover plate is disposed at a side of the second substrate away from the first substrate. When a user is at a curved center of the curved display apparatus, the audio-visual effect is optimum.

With reference to FIG. 5, the curved display apparatus includes the curved display panel shown in FIG. 3 and a cover plate 5. The second substrate is bent towards the first substrate, and the cover plate is disposed at the side of the second substrate away from the first substrate.

Optionally, the cover plate 5 in the above embodiments may also be another encapsulation film.

The above curved display apparatus may be a phone, a portable computer, a desktop, a television or a personal digital assistant and the like.

The curved display apparatus provided by the present embodiment includes the curved display panel provided by embodiments of the present disclosure, and has the corresponding functions and benefits.

The present disclosure further provides a method for manufacturing a curved display panel including steps S1 to S3.

In step S1, a first substrate and a second substrate are provided. The first substrate includes a first side frame and a second side frame opposite to each other as well as a third side frame and a fourth side frame opposite to each other; and the second substrate includes a fifth side frame and a sixth side frame opposite to each other, as well as a seventh side frame and an eighth side frame opposite to each other.

In step S2, the first substrate and the second substrate are arranged to be opposite to each other, a first frame glue is disposed between the first side frame and the fifth side frame and between the second side frame and the sixth side frame, and a second frame glue is disposed between the third side frame and the seventh side frame and between the fourth side frame and the eighth side frame.

In step S3, the first and the second side frames, the third and fourth side frames are bent with a preset curvature so that the opposite first substrate and the second substrate become curved. A width of the second frame glue is positively correlative to the preset curvature.

Optionally, both the first substrate and the second substrate are flat substrates.

Optionally, the width of the second frame glue is not less than a width of the first frame glue.

Optionally, the width of the second frame glue is greater than 1 mm.

Optionally, a Young's modulus of the second frame glue is not less than a Young's modulus of the first frame glue.

Optionally, the Young's modulus of the second frame glue is in a range of 1.6 GPa to 2 GPa.

Optionally, the first frame glue and the second frame glue include epoxy resin, acrylate, photoinitiator and thermal hardener.

Optionally, the preset curvature is 1/4000 mm⁻¹, and the width of the second frame glue is 1.1 mm.

Optionally, the preset curvature is 1/3000 mm⁻¹, and the width of the second frame glue is 1.3 mm.

Optionally, the preset curvature is 1/2000 mm⁻¹, and the width of the second frame glue is 1.7 mm.

It is to be noted that the foregoing are only technical principles and preferred embodiments of the present disclosure. It will be understood by those skilled in the art that the present disclosure is not limited to the specific embodiments described herein and that various changes, modifications and substitutions can be made by those skilled in the art without departing from the scope of the present disclosure. Therefore, although the present disclosure has been described in more detail by way of the above examples, the present disclosure is not limited to the above embodiments, but may include more equivalent embodiments without departing from the concept of the present disclosure, and the scope of the present disclosure is determined by the scope of the appended claims.

According to the curved display panel and the curved display apparatus of the present disclosure, the width of the frame glue between un-curved side frames of the first and second substrates is positively correlative to the predetermined curvature so as to increase the adhesion between the first substrate and the second substrate.

What is claimed is:

1. A curved display panel, comprising:
a first substrate;
a second substrate, opposite to the first substrate, wherein each of the first substrate and the second substrate includes two opposite first side frames having a predetermined curvature and two opposite second side frames; and
a frame glue, coated at a peripheral position between the first substrate and the second substrate and including a first frame glue for sealing the first side frames and a second frame glue for sealing the second side frames,
wherein when the curved display panel is in a planar state, a width of the second frame glue is positively correlative to the predetermined curvature.

2. The curved display panel according to claim 1, wherein, when the curved display panel is in the planar state, the width of the second frame glue is equal to or greater than a width of the first frame glue.

3. The curved display panel according to claim 1, wherein the width of the second frame glue is greater than 1 mm.

4. The curved display panel according to claim 1, wherein a Young's modulus of the second frame glue is equal to or greater than a Young's modulus of the first frame glue.

5. The curved display panel according to claim 4, wherein the Young's modulus of the second frame glue is in a range of 1.6 GPa to 2 GPa.

6. The curved display panel according to claim 1, wherein the frame glue includes epoxy resin, acrylate, photoinitiator and thermal hardener.

7. The curved display panel according to claim 1, wherein the frame glue is disposed in a non-display region of the curved display panel.

8. The curved display panel according to claim 1, wherein the first substrate is an array substrate and the second substrate is a color filter substrate, and liquid crystals fill a space between the array substrate and the color filter substrate.

9. The curved display panel according to claim 1, wherein the first substrate is bent towards the second substrate; or, the second substrate is bent towards the first substrate.

10. A curved display apparatus, comprising the curved display panel according to claim 1.

11. A method for manufacturing a curved display panel, comprising:
providing a first substrate and a second substrate, wherein the first substrate includes a first side frame and a second side frame opposite to each other as well as a third side frame and a fourth side frame opposite to each other; and the second substrate includes a fifth side frame and a sixth side frame opposite to each other as well as a seventh side frame and an eighth side frame opposite to each other;
oppositely arranging the first substrate and the second substrate; disposing a first frame glue between the first side frame and the fifth side frame and between the second side frame and the sixth side frame; and disposing a second frame glue between the third side frame and the seventh side frame and between the fourth side frame and the eighth side frame; and
bending the first and the second side frames, and the fifth and sixth side frames with a preset curvature so that the opposite first substrate and second substrate become curved,
wherein a width of the second frame glue is positively correlative to the preset curvature.

12. The method for manufacturing a curved display panel according to claim 11, wherein both the first substrate and the second substrate are flat substrates.

13. The method for manufacturing a curved display panel according to claim 11, wherein the width of the second frame glue is equal to or greater than a width of the first frame glue.

14. The method for manufacturing a curved display panel according to claim 11, wherein the width of the second frame glue is greater than 1 mm.

15. The method for manufacturing a curved display panel according to claim 11, wherein a Young's modulus of the second frame glue is equal to or greater than a Young's modulus of the first frame glue.

16. The method for manufacturing a curved display panel according to claim 15, wherein the Young's modulus of the second frame glue is in a range of 1.6 GPa to 2 GPa.

17. The method for manufacturing a curved display panel according to claim 11, wherein the frame glue includes epoxy resin, acrylate, photoinitiator and thermal hardener.

18. The method for manufacturing a curved display panel according to claim 11, wherein the preset curvature is 1/4000 mm⁻¹, and the width of the second frame glue is 1.1 mm.

19. The method for manufacturing a curved display panel according to claim 11, wherein the preset curvature is 1/3000 mm⁺¹, and the width of the second frame glue is 1.3 mm.

20. The method for manufacturing a curved display panel according to claim 11, wherein the preset curvature is 1/2000 mm⁻¹, and the width of the second frame glue is 1.7 mm.
